(19) United States
(12) Patent Application Publication
(10) Pub. No.: US 2020/0324987 A1
(43) Pub. Date: Oct. 15, 2020

(54) ACTUATED HEAD PAD FOR LOADING DOCK

(71) Applicant: DL Manufacturing Inc., North Syracuse, NY (US)

(72) Inventors: Donald L. Metz, Kirkville, NY (US); Kristian P. Garrow, Cortland, NY (US); Joshua L. Eppley, Sackets Harbor, NY (US); Kyle J. Berean, Chittenango, NY (US)

(21) Appl. No.: 16/306,548

(22) PCT Filed: Jul. 24, 2017
(86) PCT No.: PCT/US2017/043439

§ 371 Date: Nov. 30, 2018

Related U.S. Application Data
(60) Provisional application No. 62/343,146, filed on May 31, 2016.
(60) Provisional application No. 62/385,157, filed on Sep. 8, 2016.

(51) Int. Cl. B65G 69/00

(52) U.S. Cl. CPC B65G 69/008

(57) ABSTRACT

A head pad assembly for a loading dock includes a frame structure secured to a loading dock wall and a head pad portion coupled to the frame structure. The head pad portion is positioned above and extends across an opening to the loading dock, and is moveable between an upper position and a lower position. The head pad portion includes a compressible pad. The upper position of the head pad is not configured to provide a sealing function against a truck or trailer, and the lower position is configured to engage and seal the compressible pad against a roof surface of the truck or trailer.

### CROSS REFERENCE TO RELATED APPLICATION

Reference is made to and this application claims priority from and the benefit of U.S. Provisional Application Ser. No. 62/343,146, filed May 31, 2016, entitled “ACTUATED DOCK SEAL”, and U.S. Provisional Application Ser. No. 62/385,157, filed Sep. 8, 2016, entitled “ACTUATED DOCK SEAL”, which applications are incorporated herein in their entirety by reference.

### BACKGROUND OF THE INVENTION

This disclosure relates generally to sealing devices for loading docks and, more specifically, to an actuated head pad.

Most warehouses, manufacturing facilities and large retail stores include loading docks that provide a location for loading and unloading trucks and trailers. Loading docks typically include an opening in the dock wall sufficiently large to accommodate the interior region of all types of trucks and trailers. A raised loading platform positioned below the opening is roughly even with the loading dock floor. A truck or trailer backs up toward the loading dock until the rear of the cargo compartment engages the dock. The cargo compartment of the truck is thus roughly aligned with the opening of the loading dock. The truck or trailer may have an overhead door or, more commonly, hinged panel doors that swing open and are stowed against the side of the trailer.

The loading platform may include a dock leveler that provides a ramp to compensate for height differences between the loading platform and the floor of the trailer cargo area. The leveler pivots between downwardly inclined, upwardly inclined, or horizontal positions to permit forklift trucks and personnel to readily move in and out of the trailer cargo area during loading and unloading operations.

In some loading dock operations, there is a large temperature difference between the inside of the truck cargo area and the outside environment, or between the interior of the loading bay and the outside environment, or both. For example, a refrigerated trailer may dock to a refrigerated loading bay, and there may be a large temperature difference between the vehicle cargo area/loading bay and the outside environment. The cargo may include perishable items or items required to be kept cold to comply with government regulations. Both the trailer's refrigerated cargo area and the refrigerated loading bay may be controlled to approximately the same temperature, but the outside environment may be significantly warmer. In another example, the loading bay may be part of a building situated in a cold climate. The loading bay may be heated to a comfortable temperature for employees, while the outside temperature may be well below freezing. In yet another example, the loading bay may be in a building located in a hot climate. The loading bay may be air-conditioned to a comfortable temperature for employees, while the outside temperature may be hot and humid.

In each of the above examples, if the cargo area of the truck is not properly sealed against the loading dock door, gaps will form and permit leakage between the ambient air and the temperature-controlled environment. Sealing the cargo area of the vehicle from outdoor environmental conditions can be an important requirement of a loading dock structure, particularly when the cargo and the receiving dock are refrigerated. To address this need, dock seals and dock shelters have been designed to prevent the ingress of outdoor environmental conditions or contaminants (e.g., rain, snow, wind, hot/cold temperatures, insects, animals, etc.) into the interior of the dock area and cargo area of the vehicle during the loading or unloading of the vehicle. Dock shelters and dock seals also address the need to prevent the egress of refrigerated air from within the loading bay and/or vehicle cargo area to the outdoor environment.

Typically, dock seals and dock shelters include vertical members along opposing sides of the loading bay door and a horizontal head pad extending across the top of the door opening. The pads are commonly made from a wear-resistant fabric (e.g., urethane-coated fabric) surrounding a resilient material such as foam that is compressed when the back of the truck or trailer is positioned against the loading dock. However, the head pad often experiences much more wear than the side pads, and can become dislodged from its mounting structure, resulting in loss of seal and eventually expensive and time-consuming replacement.

### BRIEF SUMMARY OF THE INVENTION

In one aspect of the invention, a head pad assembly for a loading dock includes a frame structure secured to a loading dock wall and a head pad portion coupled to the frame structure. The head pad portion is positioned above and extends across an opening to the loading dock, and is moveable between an upper position and a lower position. The head pad portion includes a compressible pad. The upper position of the head pad is not configured to provide a sealing function against a truck or trailer, and the lower position is configured to engage and seal the compressible pad against a roof surface of the truck or trailer.

In another aspect of the invention, a loading dock sealing apparatus includes first and second vertical seal members positioned on either side of an opening to the loading dock. The loading dock sealing apparatus further includes a head pad assembly positioned above and extending across the opening. The head pad assembly includes a head pad portion moveable between an upper position and a lower position. The head pad portion includes a compressible pad configured to provide an environmental seal against a trailer roof when in the lower position.

### BRIEF DESCRIPTION OF THE SEVERAL VIEWS OF THE DRAWINGS

The features described herein can be better understood with reference to the drawings described below. The drawings are not necessarily to scale, emphasis instead generally being placed upon illustrating the principles of the invention. In the drawings, like numerals are used to indicate like parts throughout the various views.

FIG. 1 depicts a perspective plan view of a loading dock seal apparatus according to one embodiment of the invention, the view taken outside the building looking in towards the loading bay;

FIG. 2 depicts an enlarged perspective view of a portion of the loading dock seal apparatus shown in FIG. 1 with the canopy removed for clarity;

FIG. 3 depicts an enlarged top view of the left-hand side of the head pad assembly shown in FIG. 2, with the frame structure removed for clarity;

FIG. 4 depicts a top perspective view of the left-hand side of the head pad assembly shown in FIG. 3;

FIG. 5 depicts a top view of the head pad assembly shown in FIG. 2;

FIG. 6 depicts perspective plan view of a loading dock seal apparatus according to one embodiment of the invention with a truck parked; and

FIG. 7 depicts a top perspective view of the head pad assembly shown in FIG. 5.

### DETAILED DESCRIPTION OF THE INVENTION

Conventional dock seal structures include two vertical seal members on either side of the door opening and a horizontal head pad over the door opening. Typically, a trailer backs into the pliant dock seal structure to compress it and form a face seal along the vertical and horizontal edges of the trailer frame. One noted difficulty with loading dock operations is that a trailer will move downwards or upwards as much as four inches as the weight of the cargo increases or decreases during loading or unloading. As a result, the trailer's vertical displacement may unseat the face seal formed between the top edge of the trailer frame and the head pad structure. In addition, during loading and unloading operations a forklift moving in and out of the trailer often causes the trailer to ‘bounce’ which can disrupt the face seal and chafe the head pad material.

Another noted problem arises from differing trailer heights and door openings. In particular, some taller trailers may squash the bottom of the head pad into the door opening, such that it may obstruct loading and unloading operations. The exposed, obstructing portion of the head pad may be subject to repeated hits by pallets and the like, resulting in damage to the head pad, such as ripping and tearing.

Yet another noted problem with conventional head pad structures arises when the trailer is positioned with a trailer jockey (or yard jockey). The trailer jockey raises the front of the trailer higher than the back end, and when the back end is pushed into the pliant dock seal structure, the trailer is actually pivoted and the contact force is concentrated along the upper edge of the trailer frame, rather than equally distributed over the entire face of the frame. In a worst case scenario, the pivot angle is large enough to cause the top of the trailer to hit the building before bottom of the trailer contacts the loading dock bumpers. When the jockey lowers the trailer, the pivot angle decreases but the rotation of the top edge of the trailer frame, which is jammed into the head pad, can cause large shearing forces that may result in damage to the head pad, such as ripping and tearing. If the jockey is not removed prior to loading or unloading operations, as is sometimes the case, large shearing forces in the head pad can still occur as the trailer moves up or down due to the weight of the cargo increasing or decreasing.

Embodiments of the present invention solve these problems by providing a head pad assembly that lowers down onto the roof of the trailer. The head pad assembly includes a stationary portion that may be fixed to the building, and an actuated head pad portion that is moveable between an upper position and a lower position. The head pad remains in the upper position above the loading dock opening until the trailer engages the vertical seals and bumper. Then, the resilient head pad is lowered to engage the trailer roof. A sufficient pressure or force is applied to hold the head pad against the trailer roof, thereby effecting a seal from the outside environment. Any jarring movement (vertical or otherwise) by the trailer during loading or unloading operations is absorbed by the resiliency of the head pad material. Damage to the head pad caused by shearing forces is eliminated since the head pad engages the trailer roof, and not the face of the trailer frame. Additionally, since the head pad lowers from above the trailer, it will not obstruct the opening when moved to the lower position.

For purposes of illustration and to further explain orientation of certain features of the invention, a lateral axis is defined as substantially parallel to the loading dock wall and is denoted as the x-axis; a longitudinal axis is defined as substantially in the direction of vehicle motion when backing into the loading dock and is denoted as they-axis; and the vertical axis is denoted as the z-axis.

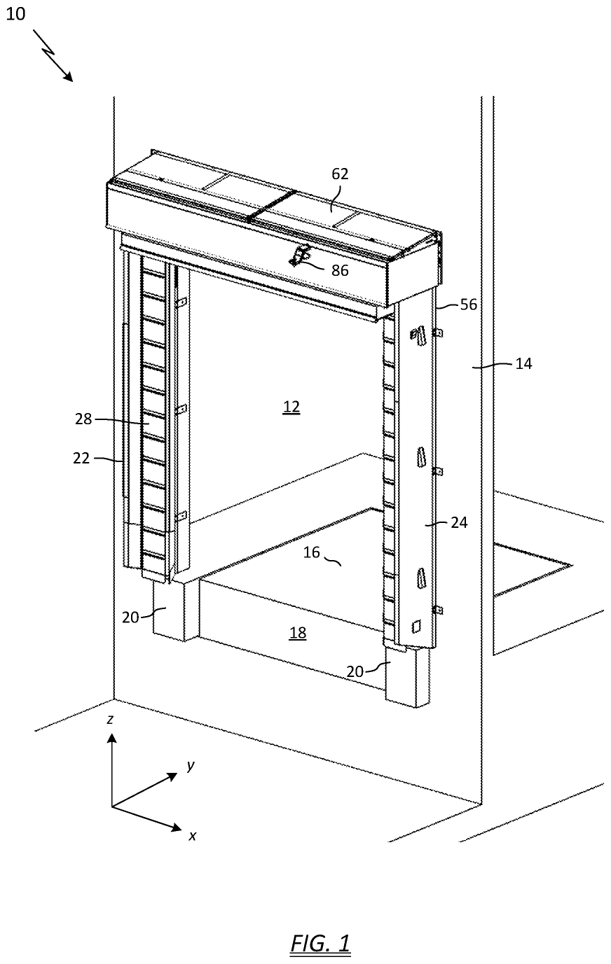

Referring to FIG. 1, a loading dock sealing apparatus 10 is configured to seal the open end of a truck or trailer from the outside environment. The loading dock sealing apparatus 10 surrounds an opening 12 in a loading dock wall 14, which is typically the exterior wall of the building. A loading platform 16 inside the loading dock area is typically at a raised elevation relative to the ground outside, so that the floor of a truck or trailer backing up to the dock will be approximately the same height. The loading dock may include a dock leveler 18 that provides an adjustable ramp to compensate for height differences between the loading platform and the floor of the trailer cargo area and permit forklift trucks and personnel to readily move in and out of the trailer cargo area during loading and unloading operations. The loading dock further includes rubber bumpers 20 affixed to the outside wall 14 to provide a means of stopping a truck or trailer when backing up to the dock. The loading dock sealing apparatus 10 may include a first vertical seal member 22 positioned to one side of the dock opening 12, and a second vertical seal member 24 positioned to the other side of the dock opening 12. The vertical seals 22, 24 may be constructed in a conventional manner. For example, each may be formed of high density polyurethane foam, roughly rectangular or trapezoidal in shape, and overwrapped with a high-grade vinyl skin (e.g., 40 oz. gauge).

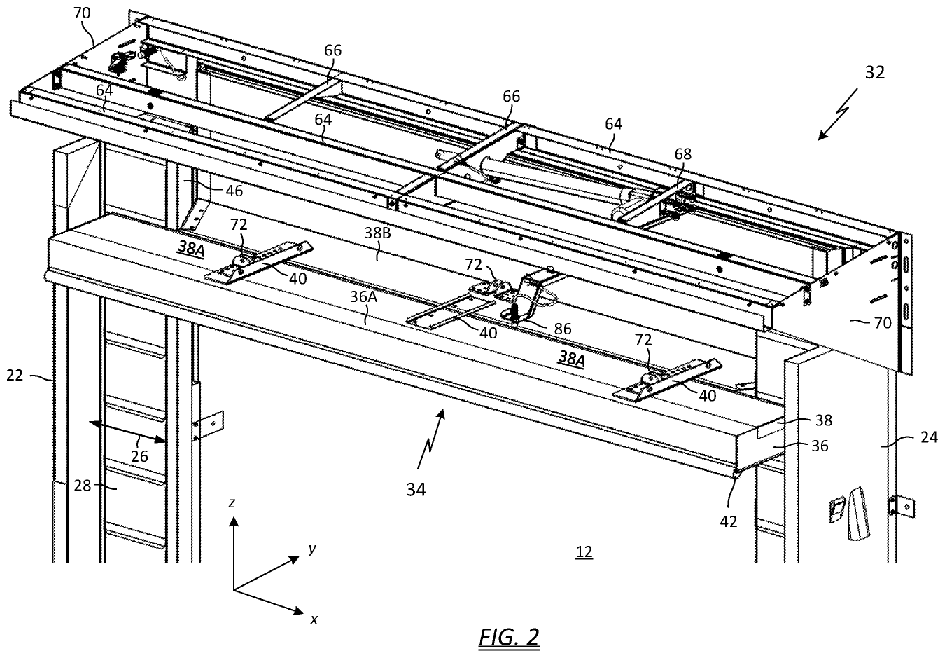

Referring to FIG. 2, according to one embodiment of the invention, the front surface 26 of the vertical seals 22, 24 may be flat, and may further include a secondary wear face 28 for added durability in the contact zone, and to provide drivers with higher visibility during docking. In the illustrated embodiment, the top surface 30 of the vertical seal 22, 24 is flat.

While the drawings have illustrated the vertical seals 22, 24 as roughly rectangular or trapezoidal in cross section, it is contemplated that other seal configurations, both conventional and otherwise, may be utilized without departing from the scope of the invention. For example, the vertical seals may have a U-shaped cross section, such as the U-Seal Non-Compression Dock Seal available from DL Manufacturing, North Syracuse, N.Y.

The loading dock sealing apparatus 10 further includes a mechanically actuated head pad assembly 32 that includes a moveable head pad portion 34. The head pad portion 34 is moveable between an upper, non-sealing position and a lower, sealing position. Stated another way, the head pad traverses vertically in a downward motion to compress and seal against the roof of the docked trailer, then raises away from the roof when loading operations are complete and trailer is ready to be moved. The moveable head pad portion 34 can include a compressible pad 36 that is configured to provide an environmental seal against the trailer roof to seal off the dock opening 12 from outside conditions. The pad 36 may be formed of polyurethane foam, for example. The moveable head pad portion 34 can further include a rigid backbone 38 to provide strength and dimensional stability to the head pad assembly 32. The backbone 38 may be formed of any suitable strong material that will withstand the weather elements, such as stainless steel. In the illustrated example, the backbone 38 is formed from 2×8 lumber. The pad 36 may be glued to the backbone 38, for example, or secured with fasteners. The pad 36 and backbone 38 can be overwrapped with a heavy gauge vinyl skin, similar to the vinyl overwrap used on the vertical seals 22, 24.

In the illustrated embodiment of the invention, the moveable head pad portion 34 includes two separate structures fastened together with one or more brackets 40. Each structure may include a compressible pad portion 36A, 36B (hidden) and a rigid backbone portion 38A, 38B. Together, the pad 36A and backbone 38A may be roughly rectangular in cross section. In one example, the head pad 36A and backbone 38A may be 8 inches to 16 inches thick (in the z-direction), and 18 inches to 24 inches deep (in the y-direction). In one embodiment, the head pad 36 may be formed of variable density foam to better control the compression characteristics. In one example, the upper portion of the foam body may be more dense than the bottom, so as to provide more weight pushing down to effect a seal.

In one embodiment of the invention, an auxiliary seal 42 can be used to provide an extra measure of sealing capability. In one example, the auxiliary seal 42 can be formed from closed cell sponge rubber, such as EPDM per ASTM D1056-2A5, it can have a tubular or partially tubular cross section, and can adhere to the front and underside surface of the head pad 36A.

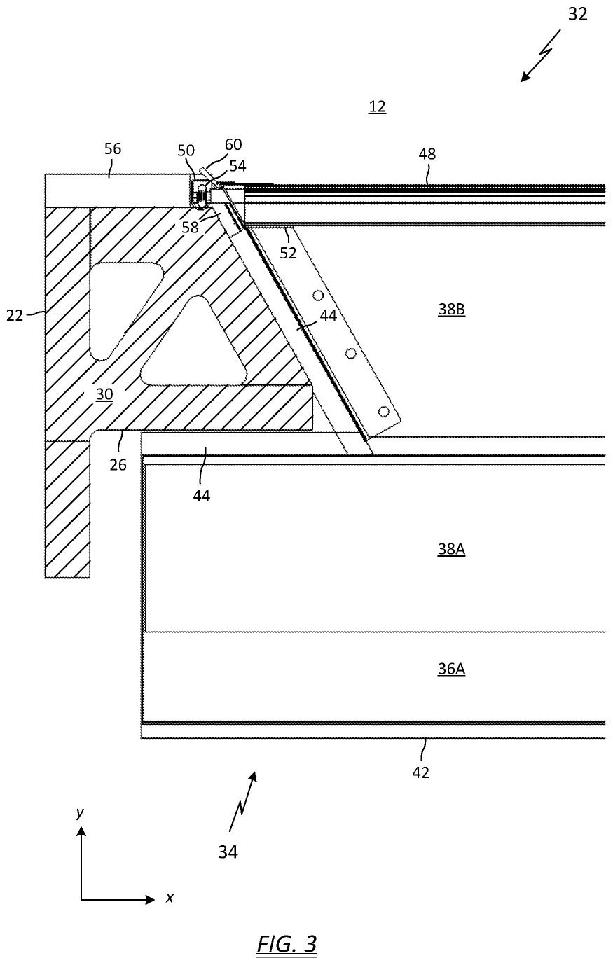

Turning now to FIG. 3, shown is a top magnified view of the head pad assembly 32 as it relates to the first vertical seal member 22. The moveable portion 34 of the head pad assembly 32 may be configured to cooperate with the vertical seals 22, 24 to provide an environmental seal against the first vertical seal member 22 (or second seal member 24) to seal off the dock opening 12 from outside conditions. For example, the geometry of the two-piece head pad portion facilitates sealing against the edges of the first and second vertical seal members 22, 24. For example, the head pad portion 36B (which is positioned under backbone portion 38B) may further extend longitudinally (i.e., in the y-direction) between the vertical seals, effectively filling the lateral gap between the vertical seal structures. In this manner, not only are the front faces 26 of the vertical seal in contact with the moveable head pad 34, but also the inside surfaces. The sides of the head pad 34 may be shaped to follow the contour of the vertical seal 22, 24 to remain in sealing contact as the head pad traverses up and down in the z-direction.

In one embodiment of the invention, the vinyl overwrap can include a flap of material 44 that abuts the seal member 22 and remains in contact with it as the head pad portion 34 traverses upwards and downwards. The head pad portion 34 may include a flap 44 extending laterally (i.e., in the x-direction) to contact the front surface 26 of the vertical seal members. In other embodiments, the head pad portion 34 may further include another flap 44 extending longitudinally (i.e., in the y-direction) to contact an inside surface 46 of the vertical seal member (shown best in FIG. 2).

The moveable portion of the head pad 34 may be unguided as it traverses up and down to engage with the top of a truck trailer. That is, a lifting mechanism could simply lower the head pad 34 onto the trailer, then lift it back up when the truck is ready to depart. In this configuration, there would be no lateral (i.e., side-to-side) or longitudinal (i.e., forward-and-backward) alignment of the head pad 34. In many scenarios this configuration is adequate.

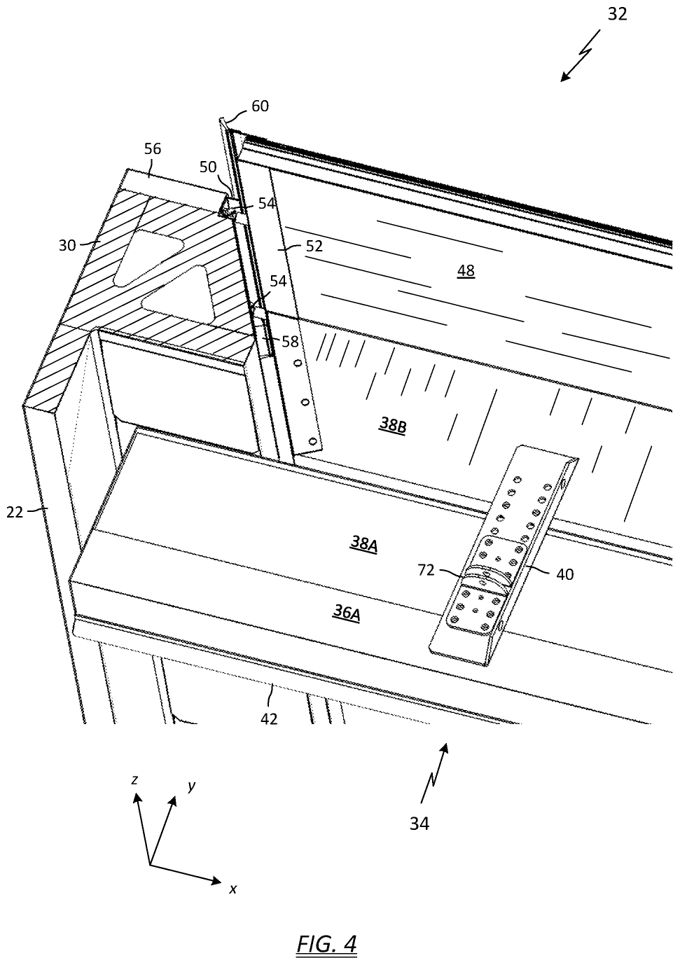

In one embodiment of the invention, however, it may be desirable to use a guide system to align the vertical path of the head pad 34. Turning now to FIG. 4, the moveable portion of the head pad 34 may also include a vertically-oriented backing plate 48 secured to the backbone portion 38B of the head pad. Each side of the backing plate 48 can be configured to ride in a stationary guide track 50 which may be vertically-oriented. In one example, the backing plate 48 can be made from a panel of a sectional loading dock door. Each side of the panel 48 may include a steel endcap 52, to which is fastened one or more roller elements 54, such as the track follower elements commonly found in overhead door installations. The guide track 50 may be configured to accept the roller elements 54 attached to the moveable portion of the head pad 34. In this manner, when the head pad traverses up and down from the upper, non-sealing position to the lower, sealing position, the roller elements 54 following in the guide track 50 will keep the moveable portion of the head pad assembly in proper vertical alignment, and prevent lateral and longitudinal misalignment.

The guide track 50 may comprise a U-shaped channel similar to the guide track commonly found in overhead door installations. In the illustrated embodiment, the guide track 50 is anchored to the same mounting block 56 as the vertical seals 22, 24. The mounting block 56 is anchored to the outside wall 14 of the loading dock. The mounting block 56 may be adapted to define a recess in which the guide track 50 can be flush-mounted.

In an alternate embodiment, not illustrated, the guide tracks 50 can be outside-mounted relative to the vertical seals 22, 24, rather than inside-mounted. In this configuration, the guide track 50 can still anchor to the mounting block 56, but a longitudinally-extending guide arm would be required to jut past the full depth of the vertical seals 22, 24. The width of the moveable portion of the head pad would then extend laterally past the vertical seals 22, 24 when joined to the guide arms. The rear portion of the head pad 36B previously disclosed would probably not be used.

In another embodiment of the invention, additional environmental sealing can be realized by incorporating a brush seal in addition to, or instead of, the fabric flap 44 on the moveable head pad portion 34. In one example, a first brush seal 58 can be mounted horizontally along the rear angled surface of the backbone 38B, with bristles facing the vertical seal 22, 24. The brush seal 58 can extend rearward such that it is in contact with, and therefore seals against, the guide track 50.

In a similar manner, a second brush seal 60 can be mounted to the endcap 52 in a vertical orientation and extend the entire height of the backing plate 48. The bristles can extend past the plane of the mounting block 56, such that they will contact, and therefore seal against, the inner wall of the dock door opening 12.

Returning briefly to FIG. 1, the head pad assembly 32 can include a canopy 62 to protect the head pad assembly 32, vertical seals 22, 24, and head pad actuating components from the weather elements. The canopy 62, which may be bolted directly to the loading dock wall 14, can include structural members to not only support the canopy roof, but also provide structural support for the head pad actuator components.

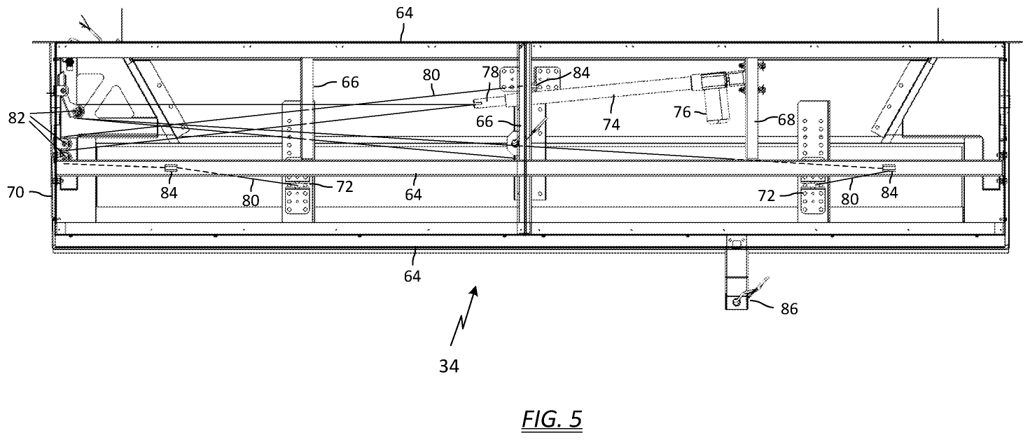

Turning now to FIG. 5, in one embodiment of the invention, the head pad assembly 32 further includes a frame comprising structural members to support the canopy roof and the head pad actuating mechanism. In one example, the frame components can include lateral support channels 64, longitudinal mid-span support brackets 66, equipment mounting brackets 68, and side support brackets 70. The frame can have provisions to allow it to be secured to the loading dock wall 14. The frame structure provides flexural rigidity to allow cable termination hardware 72 to be fastened to the backbone 38 of the head pad 34. The frame components, i.e., support channels 64, support brackets 66, and side support brackets 70, can be fabricated from steel, composite lumber material, or pressure-treated wood.

The head pad assembly 32 may further include an actuator assembly 74 configured to move the head pad 34 between the upper position and the lower position. In one embodiment of the invention, the actuator assembly 74 includes a motor 76 and a linear drive actuator, which may be mounted essentially horizontally to save space under the canopy 62. A cable and pulley system may be utilized to convert the horizontal travel of the actuator shaft 78 to a vertical motion. In one example, three lengths of 3/16″ steel cable 80 may be secured to the tip of the actuator shaft 78, passed over horizontal pulleys 82, then passed over vertically-oriented pulleys 84, then secured to the cable termination hardware 72.

When not in use, the head pad assembly 32 is stowed in its highest raised position so as to not interfere with a trailer backing up to the loading bay overhead door. Referring briefly to FIG. 1, in one example the head pad assembly 32 is stowed such that the bottom surface of the head pad 36 is at a height of approximately 13 feet 6 inches from the ground, which would provide several inches of clearance with the tallest truck trailers in the United States.

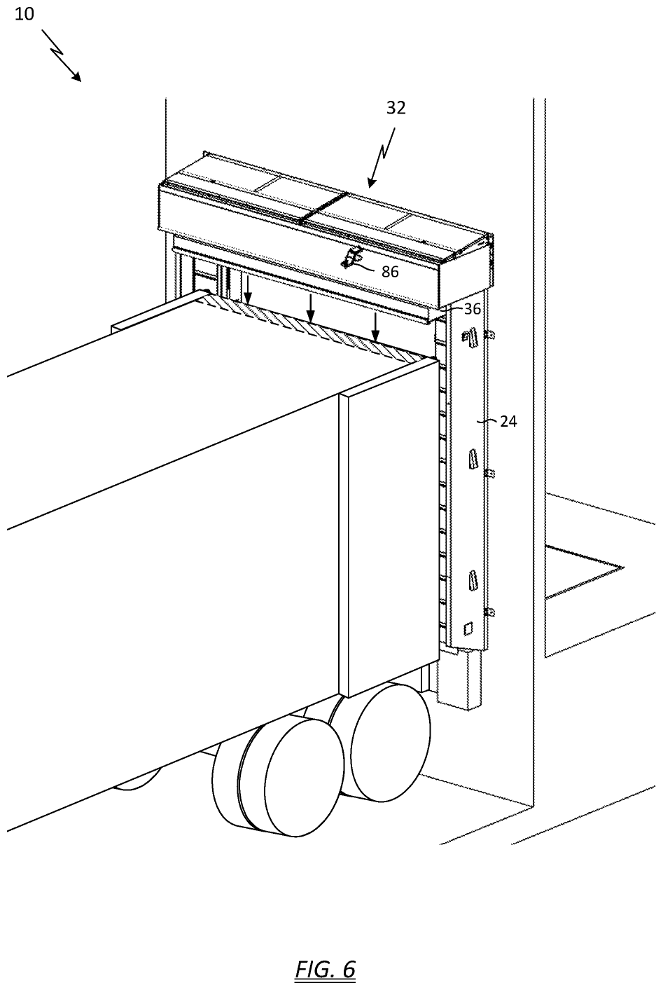

Turning now to FIG. 6, in operation, when a trailer backs into the loading dock sealing apparatus 10, the vertical edges of the trailer frame engage the front surface 26 of the vertical seals 22, 24. The trailer continues to back into the seal apparatus 10, compressing the vertical seals, until the rear bumper of the trailer impacts the loading dock bumpers 20 and stops backward movement. At this point the trailer tires can chocked.

A command signal may then be initiated to lower the head pad assembly 32. The command signal may be manual, such as by manually pressing a button or switch, or the signal may be tied to a safety interlock system, such as the Smart Chock trailer restraint system available from DL Manufacturing, North Syracuse, N.Y. The motor 76 drives the actuator shaft 78 through its range of motion, which slowly lowers the suspended head pad assembly 32 down onto the roof of the trailer, as shown by the shaded area. In one embodiment, the weight of the moveable portion is sufficient to compress the foam head pad 36 against the roof of the trailer and effect a satisfactory seal.

The head pad assembly 32 may include sensors to provide data input to a safety interlock system. In one example, a proximity sensor 86 may provide confirmation that a trailer is parked at the dock. The trailer proximity sensor 86 may be mounted to the frame of the head pad assembly 32, for example on the forward support channel 64, so the sensor remains stationary.

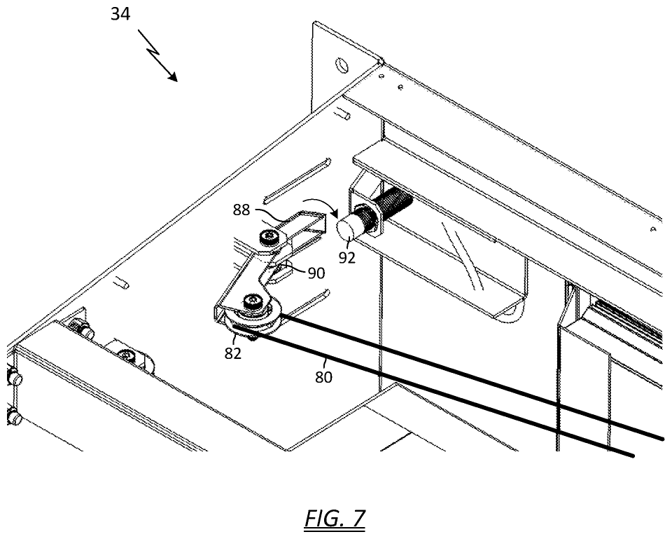

The head pad assembly 32 may further include a sensor to provide feedback when the head pad is seated against the trailer roof. One possible implementation is based upon the observation that the tension in the cable 80 will go slack when head pad seats against the trailer roof and the actuator assembly 74 continues to extend the shaft 78. Turning to FIG. 7, one of the horizontal pulleys 82 can be secured to a lever arm 88 having a torsion spring 90 attached thereto. The lever arm 88 and torsion spring 90 can be configured such that tension in the cable 80 (i.e., when the head pad is suspended) is sufficient to rotate the arm out of the way of a proximity sensor 92. However, when the head pad seats and the cable 80 goes slack, the torsion spring 90 will move the lever arm 88 in the direction of the arrow to a position in front of the lever proximity sensor 92. The sensor 92 can then send a signal to the actuator controller to stop extending the shaft 78.

There are many improvements over the prior art associated with the disclosed head pad assembly. One of the improvements is that the head pad does not compress against the loading dock wall. The compressive force applied by prior art head pads can be substantial, especially when a yard jockey applies a concentrated load. The longitudinal force against the building is not only detrimental to the building, but also may result in shear forces on the pad when trailer moves up and down, which increases wear on the fabric overwrap. Embodiments of the invention disclosed herein eliminate this problem.

Another improvement is that a better seal is effected because the degree of compression is controlled and repeatable, instead of variable with each truck driver. One benefit of this improvement is that rain water is prevented from leaking onto the dock leveler or the shipping product.

Another improvement is that there is no possibility of the head pad obstructing the door opening, which may be the case with fixed-position head pads and tall trailers.

1. A head pad assembly for a loading dock, comprising:
a frame structure secured to a loading dock wall;
a head pad portion coupled to the frame structure, the head pad portion positioned above and extending across an opening to the loading dock and moveable between an upper position and a lower position, the head pad portion having a compressible pad;
wherein the upper position of the head pad is not configured to provide a sealing function against a truck or trailer, and the lower position is configured to engage and seal the compressible pad against a roof surface of the truck or trailer.

2. The head pad assembly according to claim 1, further comprising an actuator configured to move the head pad from the upper position to the lower position.

3. The head pad assembly according to claim 2, where in the actuator comprises a linear actuator secured to the frame structure.

4. The head pad assembly according to claim 2, further comprising a cable and pulley system configured to move the head pad assembly vertically in response to actuation of the actuator.

5. The head pad assembly according to claim 4, wherein the cable and pulley system are coupled to a linear actuator, and the linear actuator is secured to the frame structure.

6. The head pad assembly according to claim 4, further comprising a sensor to provide feedback when the head pad portion is seated against the trailer roof.

7. The head pad assembly according to claim 6, further comprising a lever arm and a torsion spring coupled to a cable and pulley, the torsion spring configured to move the lever arm to activate the sensor when tension in the cable is slack.

8. The head pad assembly according to claim 1, further comprising a guide system configured to vertically align the moveable head pad portion.

9. The head pad assembly according to claim 8, wherein the guide system comprises a stationary guide track, and the moveable head pad portion further comprises a roller element configured to ride within the guide track.

10. The head pad assembly according to claim 1, wherein the head pad portion further comprises a rigid backbone.

11. A loading dock sealing apparatus, comprising:
first and second vertical seal members positioned on either side of an opening to the loading dock; and
a head pad assembly positioned above and extending across the opening, the head pad assembly comprising head pad portion moveable between an upper position and a lower position, the head pad portion having a compressible pad configured to provide an environmental seal against a trailer roof when in the lower position.

12. The loading dock sealing apparatus of claim 11, wherein the moveable head pad portion further comprises a flap configured to abut the first or second seal member and remain in contact as the head pad portion moves upwards or downwards.

13. The loading dock sealing apparatus of claim 12, wherein the flap extends along a lateral surface of the first or second seal member.

14. The loading dock sealing apparatus of claim 12, wherein the flap extends along a longitudinal surface of the first or second seal member.

15. The loading dock sealing apparatus of claim 11, wherein the head pad portion comprises a first portion configured to engage a front surface of the first or second vertical seal member, and a second portion configured to engage an inside surface of the first or second vertical seal member.

16. The loading dock sealing apparatus of claim 11, further comprising a guide system configured to vertically align the moveable head pad portion.

17. The loading dock sealing apparatus of claim 16, wherein the guide system comprises a stationary guide track, and the moveable head pad portion further comprises a roller element configured to ride within the guide track.

18. The loading dock sealing apparatus of claim 17, wherein the guide track is secured proximate to an inside surface of the first or second vertical seal member.

19. The loading dock sealing apparatus of claim 18, wherein the head pad portion further comprises a brush seal configured to contact the guide track and remain in contact as the head pad portion moves upwards or downwards.

20. The loading dock sealing apparatus of claim 11, further comprising a sensor to provide confirmation the trailer roof is in a parked position.
